(19) United States
(12) Patent Application Publication
(10) Pub. No.: US 2026/0339550 A1
(43) Pub. Date: Oct. 29, 2026

(54) ELECTRONIC DEVICE INCLUDING MEMORY AND OPERATION METHOD THEREOF

(71) Applicant: XCENA Inc., Seongnam-si (KR)

(72) Inventors: Gayoung LEE, Seongnam-si (KR); Namdae KIM, Seongnam-si (KR); Seonghyeon DO, Seongnam-si (KR)

(21) Appl. No.: 19/662,266

(22) Filed: Apr. 29, 2026

(30) Foreign Application Priority Data
Apr. 29, 2025 (KR) 10-2025-0056391

(51) Int. Cl. G06F 3/06

(52) U.S. Cl. CPC G06F 3/0656; G06F 3/0604; G06F 3/0679

(57) ABSTRACT

An electronic device includes at least one processor including a page buffer and a management module configured to convert a virtual address into a physical address based on the page buffer, a main memory configured to store a mapping table and first page data, and a swap module configured to load second page data stored in a storage into the main memory, wherein the mapping table includes mapping information between the virtual address requested by the at least one processor and the physical address of the main memory, and a count value corresponding to each of the first page data and indicating a reference number of times of the management module for each of the first page data, and the management module is configured to, in response to accessing the first page data with reference to the mapping table, increase the count value corresponding to accessed page data.

### CROSS-REFERENCE TO RELATED APPLICATION

This application claims priority to Korean Patent Application No. 10-2025-0056391, filed in the Korean Intellectual Property Office on Apr. 29, 2025, the entire contents of which being hereby incorporated by reference.

### TECHNICAL FIELDS

Aspects of some embodiments relate to an electronic device including a memory and an operation method thereof.

### BACKGROUND

Various processors in a computer system access a main memory using a virtual address for compatibility and efficiency. A memory management module supports a processor accessing the main memory by converting the virtual address into a physical address of the main memory.

A page table having mapping information may be stored in the main memory, and in response to receiving a request for the virtual address, the memory management module may access data in the main memory by searching the page table and converting the virtual address into the physical address.

Meanwhile, as semiconductor technology develops, integration of an electronic device deepens and complexity of the electronic device increases. Therefore, it is desirable to operate the electronic device accurately and efficiently. At this time, in a process in which a processor of the electronic device uses the data in the main memory, it is desirable to have a technology for accurately identifying and managing a data usage state of the processor in order to prevent an unnecessary error and improve performance.

### SUMMARY

The present disclosure provides an electronic device including a memory and an operation method thereof to solve the above problems.

The present disclosure may be implemented in various ways including a method, an apparatus (a system), or a computer program stored in a readable storage medium.

In some embodiments, an electronic device, may include at least one processor may include a page buffer and a management module configured to convert a virtual address into a physical address based on the page buffer, a main memory configured to store a mapping table and first page data, and a swap module configured to load second page data stored in a storage into the main memory, wherein the mapping table may include mapping information between the virtual address requested by the at least one processor and the physical address of the main memory, and a count value corresponding to each of the first page data and indicating a reference number of times of the management module for each of the first page data, and the management module is configured to, in response to accessing the first page data with reference to the mapping table, increase the count value corresponding to accessed page data.

In some embodiments, the swap module is configured to, in response to a failure of the management module to lookup a first virtual address requested by the at least one processor in the mapping table, check an available memory to load the second page data in the main memory.

In some embodiments, the swap module is configured to, in response to checking the available memory, load page data corresponding to the first virtual address among the second page data from the storage into the available memory.

In some embodiments, the swap module is configured to, in response to a failure of checking the available memory, select replacement candidate page data among the first page data based on a usage state of page data.

In some embodiments, the swap module is configured to, select the replacement candidate page data based on at least one of a usage frequency, a usage time, and an insertion order into the main memory of each of the first page data.

In some embodiments, the swap module is configured to, exclude page data having the count value greater than or equal to a first reference value among the replacement candidate page data from the replacement candidate page data.

In some embodiments, the swap module is configured to, select page data having the count value less than or equal to a second reference value among the replacement candidate page data as replacement target page data.

In some embodiments, the management module is configured to, in response to a synchronization request signal of the swap module, transmit a synchronization completion signal to the swap module after completing a change of the count value corresponding to page data currently being referenced, and the swap module is configured to, in response to the synchronization completion signal, read the count value.

In some embodiments, the main memory further may include, an access control circuit configured to sequentially process one or more accesses for an increase of the count value of the management module included in each of the at least one processor.

In some embodiments, the electronic device further includes a recovery cache configured to store the replacement target page data.

In some embodiments, the swap module is configured to, in response to a request for a virtual address corresponding to the replacement target page data stored in the recovery cache during a preset period, load the replacement target page into the main memory.

In some embodiments, a method of operating an electronic device performed by at least one processor may include a page buffer, and a main memory configured to store a mapping table storing mapping information between a virtual address and a physical address and first page data, the method may include performing a first search of looking up a first virtual address requested by the at least one processor in the page buffer, in response to a failure of the first search, performing a second search of looking up the first virtual address in the mapping table, in response to a failure of the second search, loading page data corresponding to the first virtual address among second page data stored in a storage into the main memory, and updating the mapping table based on the mapping information of corresponding page data loaded into the main memory, wherein the performing of the second search may include, in response to accessing the first page data with reference to the mapping table, increasing a count value of page data corresponding to the first virtual address among count values indicating a reference number of times for each of the first page data.

In some embodiments, the loading of the page data into the main memory may include checking an available memory to load the second page data in the main memory, and in response to a failure of checking the available memory, selecting replacement candidate page data among the first page data based on a usage state of page data.

In some embodiments, the selecting of the replacement candidate page data may include, selecting page data having the count value less than or equal to a reference value among the replacement candidate page data as replacement target page data.

In some embodiments, an electronic device, may include at least one processor may include an address translation unit configured to convert a virtual address into a physical address based on a page buffer, a main memory configured to store a mapping table and first page data, and a swap module configured to load second page data stored in a storage into the main memory, wherein the mapping table may include mapping information between the virtual address requested by the at least one processor and the physical address of the main memory, and a count value corresponding to each of the first page data and indicating a reference number of times that the address translation unit has accessed each of the first page data with reference to the mapping table, the address translation unit is configured to, in response to a failure of a lookup of a first virtual address requested by the at least one processor in the page buffer, lookup the first virtual address in the mapping table, and in response to a failure of the lookup of the first virtual address in the mapping table, transmit a page fault signal to the swap module, and the swap module is configured to, in response to the page fault signal, check an available memory to load the second page data in the main memory, in response to a failure of checking the available memory, select replacement candidate page data based on at least one of a usage frequency, a usage time, and an insertion order into the main memory of page data, and select page data having the count value less than or equal to a reference value among the replacement candidate page data as replacement target page data.

According to some embodiments of the present disclosure, the usage state of the page data may be identified in real time by synchronizing and managing the count value, which is a number of times each page data is being referenced, with an access of each processor.

According to some embodiments of the present disclosure, the usage state of the page data may be accurately identified by increasing or decreasing the count value of each page data according to whether the page data is used.

According to some embodiments of the present disclosure, unnecessary performance degradation of a system that may occur due to deletion of the page data being referenced by the processor may be prevented by performing a swap operation based on the count value in which the usage state of the page data is reflected in real time. In some embodiments of the present disclosure, the electronic device may improve efficiency of the system by selecting the page data not being referenced by the processor as the replacement target page data based on the count value.

According to some embodiments of the present disclosure, the usage state for each page data may be accurately reflected by sequentially controlling a change of the count value of processors.

According to some embodiments of the present disclosure, even if the processor requests deleted page data again, an unnecessary repetition of the swap operation may be prevented and performance of the system may be improved by loading the page data directly from a cache rather than accessing a storage device.

Effects of the present disclosure are not limited to the above-mentioned effects, and other effects not mentioned will be clearly understood by a person having ordinary knowledge in the technical field to which the present disclosure belongs (referred to as a "person skilled in the art") from the description of the claims.

### BRIEF DESCRIPTION OF THE DRAWINGS

The above and other embodiments and features of the present disclosure will become more apparent by describing in detail example embodiments thereof with reference to the attached drawings, in which:

FIG. 1 is a block diagram illustrating an example of a computer system according to an embodiment of the present disclosure.

FIG. 2 is a block diagram illustrating an example of a memory system according to an embodiment of the present disclosure.

FIG. 3 illustrates an example of data access according to an embodiment of the present disclosure.

FIG. 4 illustrates an example of data access according to an embodiment of the present disclosure.

FIG. 5 illustrates an example of data replacement according to an embodiment of the present disclosure.

FIG. 6 illustrates an example of data replacement according to an embodiment of the present disclosure.

FIG. 7 is a flowchart illustrating an example of a data replacement method according to an embodiment of the present disclosure.

FIG. 8 illustrates an example of data access according to an embodiment of the present disclosure.

FIG. 9 illustrates an example of data access according to an embodiment of the present disclosure.

FIG. 10 is a flowchart illustrating an example of a data access method according to an embodiment of the present disclosure.

### DETAILED DESCRIPTION

Hereinafter, specific details for implementation of the present disclosure will be described in detail with reference to the accompanying drawings. In some embodiments, in the following description, a detailed description of a widely known function or configuration will be omitted when the detailed description may unnecessarily obscure the subject matter of the present disclosure.

In the accompanying drawings, identical or corresponding components are given identical reference numerals. For example, in the description of the following embodiments, overlapping descriptions of identical or corresponding components may be omitted. In some embodiments, even if the description of the component is omitted, the component is not intended to be excluded from an embodiment.

Advantages and features of disclosed embodiments and a method for achieving the advantages and features of the disclosed embodiments will become clear with reference to the embodiments described below together with the accompanying drawings. In some embodiments, the present disclosure is not limited to the embodiments disclosed below and may be implemented in various different forms, and the present embodiments are provided merely to complete the present disclosure and to fully inform the person skilled in the art of the scope of the invention.

Terms used in the present specification will be briefly described, and the disclosed embodiments will be described in detail. The terms used in the present specification have selected general terms currently widely used as much as possible while considering functions in the present disclosure, but the terms may vary depending on an intention of a technician working in a related field, a precedent, an emergence of a new technology, and the like. For example, in a specific case, there is a term arbitrarily selected by an applicant, and in the specific case, a meaning of the term will be described in detail in a description part of a corresponding invention. Accordingly, the terms used in the present disclosure should be defined based on the meaning of the terms and contents throughout the present disclosure, rather than a simple name of the term.

A singular expression in the present specification includes a plural expression unless the context clearly specifies that the singular expression is singular. For example, the plural expression includes the singular expression unless the context clearly specifies that the plural expression is plural. When a part includes a component throughout the specification, the part does not exclude another component but may further include the other component unless specifically stated to the contrary.

For example, a term 'module' or 'unit' used in the specification means a software or hardware component, and the 'module' or 'unit' performs certain roles. In some embodiments, the 'module' or 'unit' is not meant to be limited to software or hardware. The 'module' or 'unit' may be configured to reside on an addressable storage medium or may be configured to reproduce one or more processors. Accordingly, as an example, the 'module' or 'unit' may include at least one of components such as software components, object-oriented software components, class components, and task components, and processes, functions, properties, procedures, subroutines, segments of program code, drivers, firmware, microcode, circuitry, data, databases, data structures, tables, arrays, or variables. Functions provided within the components and the 'modules' or 'units' may be combined into a smaller number of components and 'modules' or 'units' or may be further separated into additional components and 'modules' or 'units'.

According to an embodiment of the present disclosure, the 'module' or 'unit' may be implemented with a processor and a memory. The 'processor' should be broadly interpreted to include a general-purpose processor, a central processing unit (CPU), a microprocessor, a digital signal processor (DSP), a controller, a microcontroller, a state machine, and the like. In some environments, the 'processor' may refer to an application-specific integrated circuit (ASIC), a programmable logic device (PLD), a field programmable gate array (FPGA), and the like. The 'processor' may refer to a combination of processing devices such as, for example, a combination of a DSP and a microprocessor, a combination of a plurality of microprocessors, a combination of one or more microprocessors in conjunction with a DSP core, or a combination of any other such configurations. For example, the 'memory' should be broadly interpreted to include any electronic component capable of storing electronic information. The 'memory' may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and the like. The memory is said to be in electronic communication with the processor if the processor may read information from and/or write information to the memory. The memory integrated into the processor is in electronic communication with the processor.

For example, terms such as first and second used in the following embodiments are only used to distinguish one component from another component, and a nature, an order, or a sequence of a corresponding component is not limited by the terms.

For example, in the following embodiments, when a component is described as being 'connected', 'coupled', or 'accessed' to another component, the component may be directly connected or accessed to the other component, but it should be understood that still another component may be 'connected', 'coupled', or 'accessed' between each component.

For example, 'includes (comprises)' and/or 'including (comprising)' used in the following embodiments do not exclude a presence or an addition of one or more other components, steps, operations, and/or elements to mentioned components, steps, operations, and/or elements.

In the present disclosure, a 'system' may include at least one device of a server device and a cloud device, but is not limited thereto. For example, the system may be configured with one or more server devices. As another example, the system may be configured with one or more cloud devices. As still another example, the system may be configured and operated with the server device and the cloud device together.

In the present disclosure, 'each of a plurality of A' or 'each of the plurality of A' may refer to each of all components included in the plurality of A, or may refer to each of some components included in the plurality of A.

Hereinafter, various embodiments of the present disclosure will be described in detail according to the accompanying drawings. A position and/or a structure of various configurations and/or blocks illustrated and described in the drawings are exemplary and are not limited thereto. For example, some configurations may be added or omitted, or may be configured with a position and a structure different from what is illustrated. For example, a flowchart illustrated in the drawings and a description of the flowchart are merely an example, and may be implemented differently in some embodiments. For example, one or more steps may be omitted, an order of each step may be changed, one or more steps may be performed overlappingly, or one or more steps may be repeated multiple times.

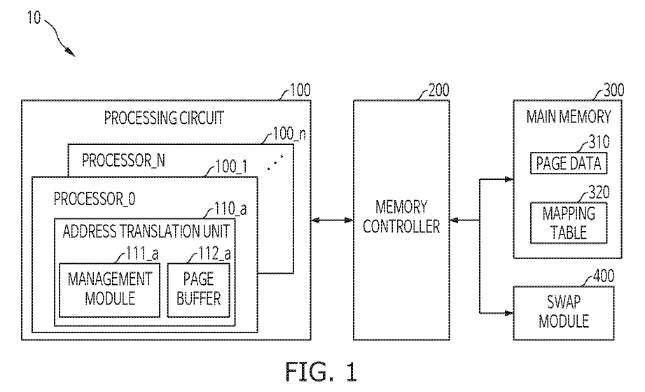

FIG. 1 is a block diagram illustrating an example of a computer system according to an embodiment of the present disclosure.

Referring to FIG. 1, a computer system 10 may include a processing circuit 100, a memory controller 200, a main memory 300, and a swap module 400. The processing circuit 100 may include a plurality of processors 100_1, ..., 100_n, and each of the plurality of processors 100_1, ..., 100_n may include an address translation unit ATU. For example, a first processor 100_1 may include a first address translation unit 110_a.

Each of the plurality of processors 100_1, ..., 100_n may include a plurality of processing cores that independently perform an operation. The plurality of processors 100_1, ..., 100_n may be, for example, a Graphic Processing Unit (GPU) capable of performing a large-scale parallel operation. In some embodiments, the present disclosure is not limited thereto, and the plurality of processors 100_1, ..., 100_n may be a Central Processing Unit (CPU), a Neural Processing Unit (NPU), and the like. The processing circuit 100 may execute various application programs or tools to be driven on an operating system (OS) basis. In an embodiment, the swap module 400 may be loaded into the main memory 300 and driven by the processing circuit 100.

The memory controller 200 may control the main memory 300 and/or the swap module 400 based on a command of the plurality of processors 100_1, ..., 100_n. That is, various functions may be provided so that the plurality of processors 100_1, ..., 100_n may control the main memory 300 and/or the swap module 400. For example, the memory controller 200 may access the main memory 300 or communicate with the swap module 400 according to a request of the plurality of processors 100_1, ..., 100_n.

The main memory 300 may store data and a command to be used in the plurality of processors 100_1, ..., 100_n. For example, the main memory 300 may be a Dynamic Random Access Memory (DRAM), a Double Data Rate Synchronous DRAM (DDR SDRAM), a Nonvolatile RAM (NVRAM), and the like. For example, the main memory 300 may also store data in a file system format, and as an example, may store an operating system (OS) program. In an embodiment, the main memory 300 may include first page data 310 and a mapping table 320. Each of the plurality of processors 100_1, ..., 100_n may access the first page data 310 by referring to the mapping table 320 through a virtual address.

The computer system 10 may be controlled by the operating system (OS). The operating system may allocate a virtual memory for each of processes executed in the plurality of processors 100_1, ..., 100_n. Each of the plurality of processors 100_1, ..., 100_n may access the main memory 300 to obtain data in order to execute the processes.

Each of the plurality of processors 100_1, ..., 100_n may access the main memory 300 based on a virtual address VA pointing to an area of the virtual memory. The plurality of processors 100_1, ..., 100_n may include the address translation unit ATU to convert the virtual address into a physical address PA pointing to a physical area of the main memory 300. Each address translation unit may include a management module and a page buffer. In an embodiment, the management module may be referred to as a Memory Management Unit (MMU), and the page buffer may be referred to as a Translation Lookaside Buffer (TLB). For example, the first address translation unit 110_a may include a first management module 111_a and a first page buffer 112_a. Hereinafter, for convenience of description, a description is given based on the first processor 100_1, and the description of the first processor 100_1 may be applied to all of the plurality of processors 100_1, ..., 100_n.

The first management module 111_a may refer to the mapping table 320 of the main memory 300 to convert the virtual address into the physical address. The mapping table 320 may include a plurality of Page Table Entries (PTEs) indicating the physical address corresponding to the virtual address, and may be stored in the main memory 300. For example, the first address translation unit 110_a may include the first page buffer 112_a. The first page buffer 112_a may cache recently used page table entries so that a frequently accessed virtual address may be quickly converted into the physical address. That is, a part of the mapping information of the mapping table 320 may be stored in the first page buffer 112_a.

When a request for the virtual address of the first processor 100_1 occurs, the first management module 111_a may first lookup the first page buffer 112_a to find a page table entry including the physical address corresponding to the virtual address. For example, the first management module 111_a may first lookup a second mapping table (not shown) stored in the first page buffer 112_a. When the page table entry including the physical address corresponding to the virtual address exists in the first page buffer 112_a (that is, the second mapping table), that is, in a case of a page buffer hit (for example, a TLB hit), the first management module 111_a may convert the virtual address into the physical address using the page table entry. In some embodiments, when the page table entry does not exist in the first page buffer 112_a, that is, when a page buffer miss (for example, a TLB miss) occurs, the first management module 111_a may generate a request for looking up the mapping table 320 of the main memory 300.

That is, the first management module 111_a may lookup the mapping table 320 to find the page table entry corresponding to the virtual address. When the page table entry corresponding to the virtual address exists in the mapping table 320, that is, in a case of a page table hit, the first management module 111_a may convert the virtual address into the physical address using the page table entry. In an embodiment, the mapping table 320 may include a count value indicating the reference number of times that the plurality of processors 100_1, ..., 100_n access each page data as described above. In some embodiments, without being limited thereto, the count value may be stored in a separate area (for example, a separate count table) other than the mapping table 320.

In some embodiments, when the page table entry does not exist in the mapping table 320, that is, when a page table miss occurs, the first management module 111_a may transmit a page fault signal notifying that the page data requested by the first processor 100_1 is not loaded in the main memory 300 to the swap module 400. The swap module 400 may load the page data requested by the first processor 100_1 into the main memory 300 in response to the page fault signal. In an embodiment, the swap module 400 may perform a load operation based on the count value indicating the reference number of times that the plurality of processors 100_1, ..., 100_n access each page data. The swap module 400 is not limited to the present embodiment and may be implemented in various ways. For example, as described above, the swap module 400 may be a software module loaded into the main memory 300 and driven by the processing circuit 100, and thus may be a module that performs a swap operation in a software layer. That is, although the swap module 400 is illustrated as a separate module in the present drawing, the swap module 400 is not limited thereto and may be a module driven within the main memory 300.

The electronic device according to an embodiment of the present disclosure may prevent an error caused by a replacement of the page data being referenced by processors by performing a memory load operation based on the number of times each page data is being referenced by the plurality of processors.

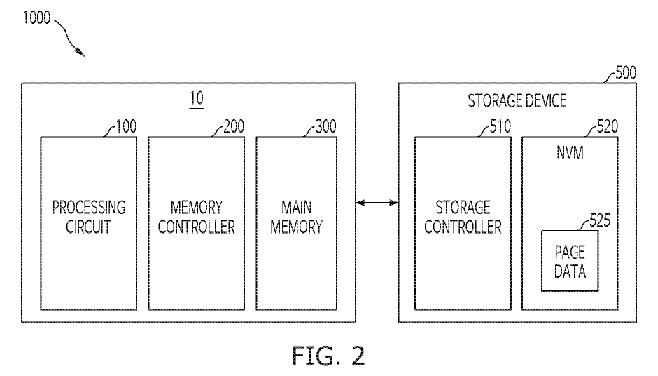

FIG. 2 is a block diagram illustrating an example of a memory system according to an embodiment of the present disclosure.

Referring to FIG. 2, a memory system 1000 may include the computer system 10 and a storage device 500, and the storage device 500 may include a storage controller 510 and a nonvolatile memory 520. The computer system 10 may correspond to the computer system 10 of FIG. 1, and may refer to various systems referred to as a host. For example, the computer system 10 may refer to a data processing device capable of processing data such as a CPU, a processor, a microprocessor, or an Application Processor (AP). The computer system 10 may execute the operating system (OS) and/or various applications. For example, the computer system 10 may be implemented as a System-On-a-Chip (SoC).

The storage device 500 may include the storage controller 510 and the nonvolatile memory 520. The storage device 500 may communicate with the computer system 10 through various interfaces. The storage device 500 may store data DATA in the nonvolatile memory 520 or read the data DATA from the nonvolatile memory 520 in response to a command such as read/write received from the computer system 10. For example, the storage controller 510 may control the nonvolatile memory 520 to write data to the nonvolatile memory 520 in response to a write request from the computer system 10, or may control the nonvolatile memory 520 to read data stored in the nonvolatile memory 520 in response to a read request from the computer system 10. In some embodiments, the storage device 500 is not limited to the present embodiment and may be implemented in various ways. For example, the storage controller 510 may not be included in the storage device 500, but may be located outside the storage device 500 to control the nonvolatile memory 520 based on the command of the computer system 10.

The nonvolatile memory 520 may include a Memory Cell Array (MCA), and may be implemented as a flash memory device. For example, the nonvolatile memory 520 may include a NAND flash memory device. In some embodiments, the present disclosure is not limited thereto, and a nonvolatile memory 120 may include a resistive memory device such as a resistive RAM (ReRAM), a phase change RAM (PRAM), and a magnetic RAM (MRAM). In an embodiment, the nonvolatile memory 520 may include second page data 525. As described above with reference to FIG. 1, when the page table entry corresponding to the virtual address requested by the processing circuit 100 does not exist in the mapping table of the main memory 300, that is, when the page table miss occurs, the computer system 10 may load page data including the physical address corresponding to the virtual address requested by the processing circuit 100 among the second page data 525 stored in the nonvolatile memory 520 into the main memory 300. In an embodiment, when the main memory 300 does not have a free space to load the second page data 525, the computer system 10 may replace a part of the page data stored in the main memory 300 with the second page data 525 based on the count value indicating the reference number of times that the processing circuit 100 accesses the page data stored in the main memory 300.

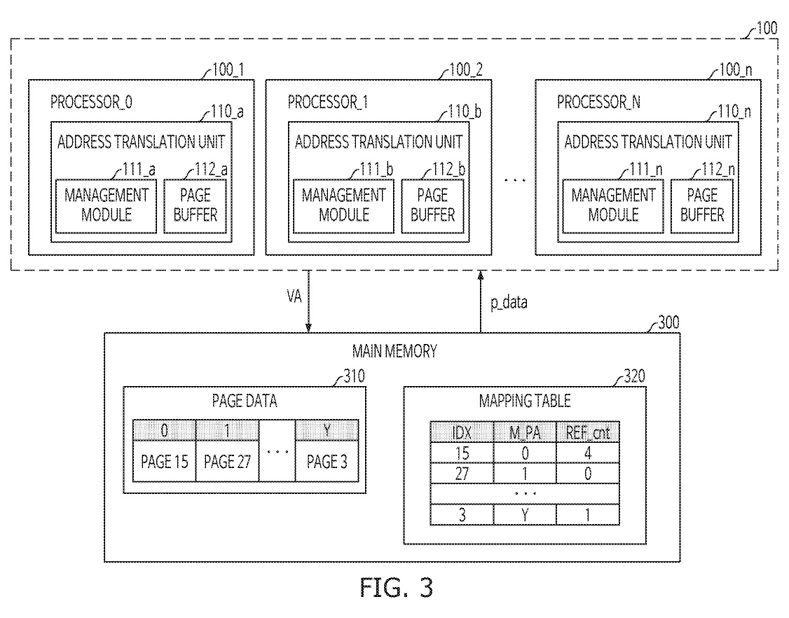

FIG. 3 illustrates an example of data access according to an embodiment of the present disclosure.

Referring to FIG. 3, the main memory 300 may include the stored first page data 310 and the mapping table 320 including a count value REF_cnt indicating the reference number of times of the plurality of processors 100_1, ..., 100_n for each of the first page data 310.

The mapping table 320 may include an index IDX, a physical address M_PA, and the count value REF_cnt of the page data to indicate the reference number of times for each of the first page data 310. For example, the physical address M_PA may mean a Page Frame Number (PFN). The index IDX may indicate information on each page data.

For example, the first processor 100_1 may request a virtual address VA, and the first management module 111_a may first lookup the virtual address VA in the first page buffer 112_a. When the lookup of the virtual address VA in the first page buffer 112_a fails, the first management module 111_a may access the main memory 300 using the virtual address VA. The first management module 111_a may lookup the virtual address VA in a page table included in the mapping table 320 of the main memory 300 (or a page table existing separately from the mapping table 320). When the lookup of the virtual address VA in the mapping table 320 succeeds (that is, the page table hit), the first management module 111_a may increase the count value REF_cnt corresponding to the virtual address VA in the mapping table 320 based on the index IDX and/or the physical address M_PA. Thereafter, target page data p_data may be read by accessing the physical address of the main memory 300 corresponding to the virtual address VA.

For example, the first management module 111_a may update the mapping information for the target page data p_data in the first page buffer 112_a. That is, the first management module 111_a may cache a recently used page table entry corresponding to the virtual address VA so that the frequently accessed virtual address may be quickly converted into the physical address later.

The electronic device according to an embodiment of the present disclosure may identify the usage state of the page data in real time by managing the number of times each page data is being referenced in synchronization with the access of each processor.

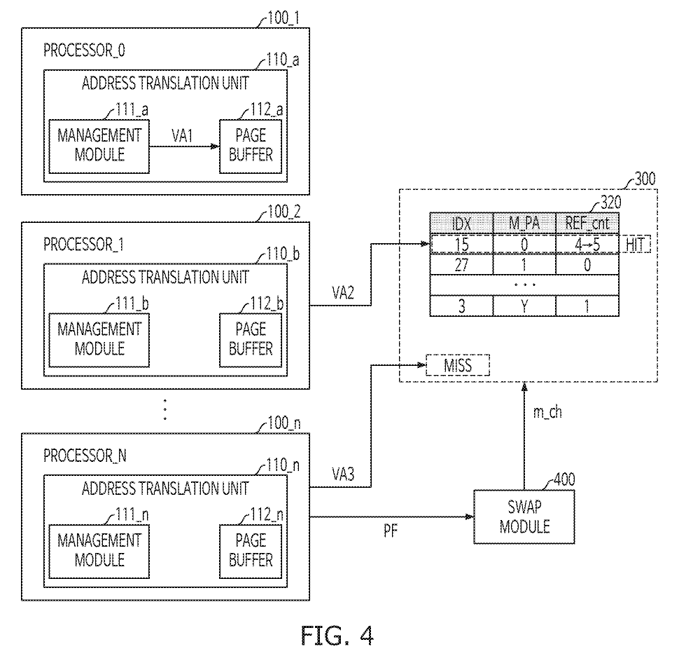

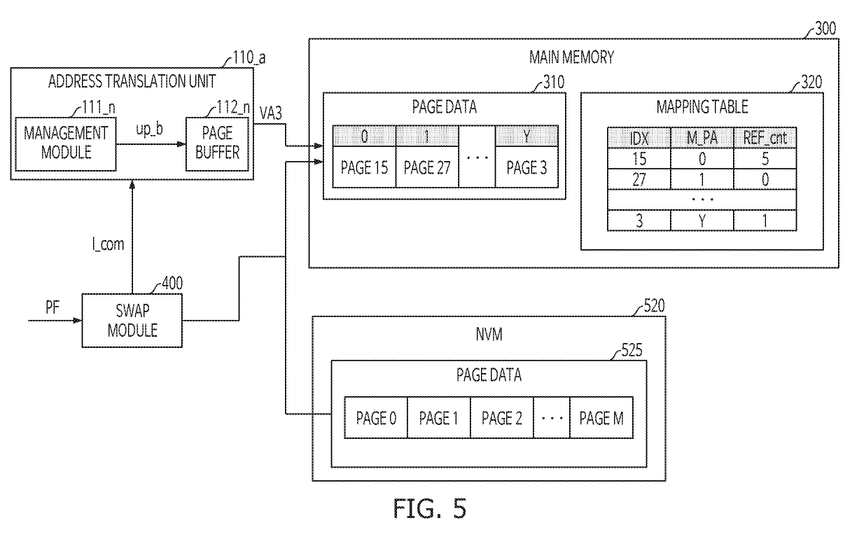

FIG. 4 illustrates an example of data access according to an embodiment of the present disclosure. FIG. 5 illustrates an example of data replacement according to an embodiment of the present disclosure.

Referring to FIGS. 4 and 5, the swap module 400 may check an available memory to load necessary page data.

In an embodiment, the first processor 100_1 may request a first virtual address VA1, and in response to this, the first management module 111_a may first lookup the first virtual address VA1 in the first page buffer 112_a. When the lookup of the virtual address VA in the first page buffer 112_a succeeds (that is, the page buffer hit), the first management module 111_a may access the main memory 300 based on the physical address converted according to the first page buffer 112_a without having to transmit a request related to the first virtual address VA1 to the main memory 300. In this case, because the first processor 100_1 is already referencing the page data corresponding to the first virtual address VA1, the count value REF_cnt of the mapping table 320 may not be increased.

In another embodiment, a second processor 100_2 may request a second virtual address VA2, and a second management module 111_b may first lookup the second virtual address VA2 in a second page buffer 112_b. When the lookup of the second virtual address VA2 in the second page buffer 112_b fails (that is, the page buffer miss), the second management module 111_b may access the main memory 300 using the second virtual address VA2. More specifically, the second management module 111_b may search for a page table entry corresponding to the second virtual address VA2 in the mapping table 320 based on a Virtual Page Number (VPN) and an offset included in the second virtual address VA2. When the lookup of the page table entry corresponding to the second virtual address VA2 succeeds (that is, the page table hit), the second management module 111_b may obtain the physical address M_PA of the page data corresponding to the second virtual address VA2. As illustrated in FIG. 4, the second management module 111_b may increase the count value REF_cnt of the page data corresponding to the second virtual address VA2 in the mapping table 320 based on the obtained physical address M_PA.

In another embodiment, an n-th processor 100_n may request a third virtual address VA3, and an n-th management module 111_n may first lookup the third virtual address VA3 in an n-th page buffer 112_n. When the lookup of the third virtual address VA3 in the n-th page buffer 112_n fails, the n-th management module 111_n may access the main memory 300 using the third virtual address VA3. More specifically, the n-th management module 111_n may search for a page table entry corresponding to the third virtual address VA3 in the mapping table 320 based on the virtual page number VPN and the offset included in the third virtual address VA3. When the lookup of the page table entry corresponding to the third virtual address VA3 in the mapping table 320 fails (that is, the page table miss), the n-th management module 111_n may transmit a page fault signal PF notifying that the page data requested by the n-th processor 100_n is not loaded in the main memory 300 to the swap module 400. In response to the reception of the page fault signal PF, the swap module 400 may check whether there is an empty space, that is, the available memory, in the main memory 300. For example, the swap module 400 may check whether the available memory is present by transmitting an available memory check signal m_ch to the main memory 300. In some embodiments, the swap module 400 may check whether the available memory is present based on information on a page pool secured inside the swap module 400 without transmitting a separate available memory check signal m_ch.

When checking the available memory succeeds, that is, when the main memory 300 has the free space to load the page data, the swap module 400 may load the second page data 525 of the nonvolatile memory 520 into the main memory 300 as illustrated in FIG. 5. More specifically, when the available memory is secured, the swap module 400 may search for the page data corresponding to the third virtual address VA3 among the second page data 525 in the nonvolatile memory 520. The swap module 400 may access the page data corresponding to the third virtual address VA3 based on a page table (not shown) in which mapping information between the virtual address and the physical address of the nonvolatile memory 520 is stored. The swap module 400 may load the page data corresponding to the third virtual address VA3 among the second page data 525 into the available memory secured in the main memory 300. Thereafter, the swap module 400 may transmit a load completion signal l_com notifying that the load of the page data is completed to an n-th address translation unit 110_n. The n-th management module 111_n may access the main memory 300 through the third virtual address VA3 in response to the reception of the load completion signal l_com. Because the page data uploaded from the nonvolatile memory 520 by the swap module 400 is stored in the main memory 300 as the first page data 310, the n-th management module 111_n may succeed in looking up the page table entry corresponding to the third virtual address VA3 in the mapping table 320. Accordingly, the n-th management module 111_n may obtain the physical address M_PA (for example, the PFN) of the page data corresponding to the third virtual address VA3, and based on the physical address M_PA, may increase the count value REF_cnt of the page data corresponding to the third virtual address VA3 in the mapping table 320. For example, the n-th management module 111_n may transmit a buffer update signal up_b to the n-th page buffer 112_n to cache mapping information for the third virtual address VA3.

In some embodiments, although not illustrated in the present drawing, the second processor 100_2 may update mapping information of the second virtual address VA2 and the physical address corresponding to the second virtual address VA2 in the second page buffer 112_b by newly referencing the page data corresponding to the second virtual address VA2. At this time, the second page buffer 112_b may not have the free space to store new mapping information, and the second management module 111_b may delete any one of the mapping information stored in the second page buffer 112_b based on a Least Recently Used (LRU), a First in First Out (FIFO), and/or a Least Frequently Used (LFU) algorithm, and the like. At this time, because deletion of the mapping information means that the second management module 111_b no longer references the page data corresponding to the deleted mapping information, the second management module 111_b may decrease the count value REF_cnt of the page data corresponding to the deleted mapping information in the mapping table 320.

The electronic device according to an embodiment of the present disclosure may accurately identify the usage state of the page data by storing the number of times each page data is being referenced as the count value REF_cnt and increasing or decreasing the count value REF_cnt according to whether the page data is used.

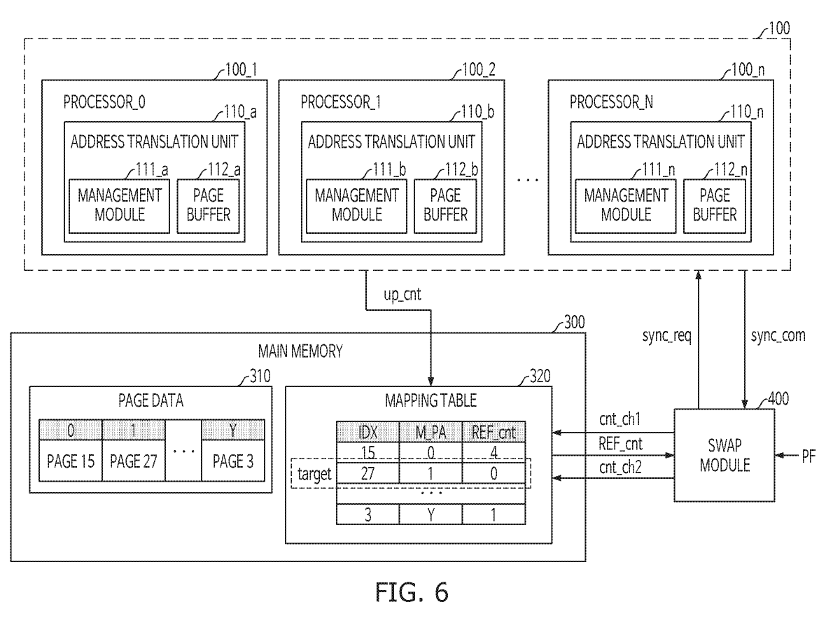

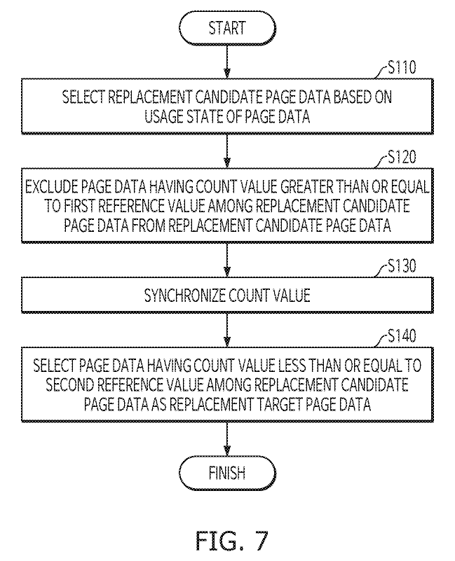

FIG. 6 illustrates an example of data replacement according to an embodiment of the present disclosure. FIG. 7 is a flowchart illustrating an example of a data replacement method according to an embodiment of the present disclosure.

Referring to FIGS. 6 and 7, when the main memory 300 does not have the available memory to load the necessary page data, the swap module 400 may select the replacement candidate page data and/or the replacement target page data to be deleted among the first page data 310 based on the count value REF_cnt.

As described above, the swap module 400 may check the available memory in response to the page fault signal PF. When the main memory 300 does not have the available memory, in step S110, the swap module 400 may select the replacement candidate page data based on the usage state of each of the first page data 310. In an embodiment, the swap module 400 may select the replacement candidate page data among the first page data 310 based on the Least Recently Used (LRU), the First in First Out (FIFO), and/or the Least Frequently Used (LFU) algorithm, and the like. In some embodiments, the method by which the swap module 400 selects the replacement candidate page data among the first page data 310 is not limited to the present embodiment and may be implemented in various ways. That is, the swap module 400 may select the replacement candidate page data according to various algorithms and/or methods for selecting data to be deleted based on the usage state of data (the usage frequency of data, the usage time, and/or the insertion order, and the like).

In step S120, the swap module 400 may exclude page data having the count value REF_cnt greater than or equal to the first reference value among the replacement candidate page data from the replacement candidate page data. In an embodiment, the swap module 400 may transmit a first count check signal cnt_ch1 to the main memory 300 to read the count value REF_cnt of each of the replacement candidate page data. The swap module 400 may compare the read count value REF_cnt of each of the replacement candidate page data with the first reference value. When the count value REF_cnt is greater than or equal to a certain value, the count value REF_cnt may mean that corresponding page data is being referenced by the processor. For example, when the count value REF_cnt is greater than or equal to 1, the count value REF_cnt may mean that the page data corresponding to the count value REF_cnt is being referenced by at least one processor. Accordingly, when the page data corresponding to the count value REF_cnt having a value of 1 or more is deleted from the main memory 300, data being referenced by the at least one processor is deleted and a serious error may occur. Accordingly, the swap module 400 may exclude the page data having the count value REF_cnt greater than or equal to the first reference value among the replacement candidate page data from the replacement candidate page data in order to prevent an error. In some embodiments, the method by which the swap module 400 selects the replacement candidate page data among the first page data 310 is not limited to the present embodiment and may be implemented in various ways. For example, the swap module 400 may omit step S110 and perform step S120. That is, the swap module 400 may read all the count values REF_cnt of each of the first page data 310, and then select page data excluding the page data having the count value REF_cnt greater than or equal to the first reference value as the replacement candidate page data.

In step S130, the swap module 400 may synchronize the count value REF_cnt of the replacement candidate page data. As described above, the count value REF_cnt is information reflecting whether the plurality of processors 100_1, ..., 100_n reference each page data, and therefore the count value REF_cnt may fluctuate in real time. For example, the count value REF_cnt referenced in the process of the swap module 400 selecting the replacement candidate page data or excluding some page data from the replacement candidate page data may be a value before whether the plurality of processors 100_1, ..., 100_n reference the page data is reflected. That is, the count value REF_cnt may be a value read before the plurality of processors 100_1, ..., 100_n change the count value REF_cnt. In some embodiments, the count value REF_cnt may have changed after the process of the swap module 400 selecting the replacement candidate page data or excluding some page data from the replacement candidate page data. Accordingly, the swap module 400 may synchronize the count value REF_cnt so that the count value REF_cnt may accurately (that is, in real time) reflect information on the page data being referenced.

In an embodiment, the swap module 400 may transmit a synchronization request signal sync_req to the processing circuit 100 to synchronize the count value REF_cnt. Each of a plurality of management modules 111_a, 111_b, ..., 111_n of the plurality of processors 100_1, ..., 100_n of the processing circuit 100 may synchronize the count value REF_cnt for the page data currently being referenced in response to the synchronization request signal sync_req. More specifically, even if the plurality of processors 100_1, ..., 100_n requested a change in the count value REF_cnt corresponding to the page data being referenced or for which reference is completed, it may take time for the count value REF_cnt stored in the mapping table 320 to actually be changed due to communication and channel delays, and the like. Accordingly, the swap module 400 may transmit the synchronization request signal sync_req to the plurality of management modules 111_a, 111_b, ..., 111_n to read an accurate (that is, actually completely changed) count value REF_cnt. The plurality of management modules 111_a, 111_b, ..., 111_n may transmit a synchronization completion signal sync_com to the swap module 400 after a time point at which the change of the count value REF_cnt is actually completed according to the request even if a count value change request up_cnt has been made in response to the synchronization request signal sync_req.

The swap module 400 may transmit a second count check signal cnt_ch2 in response to the synchronization completion signal sync_com, and may read an updated count value REF_cnt of each of the replacement candidate page data in the mapping table 320.

In an embodiment, the above-described synchronization operation of the count value REF_cnt may be performed for all page data, or may be performed only for the replacement candidate page data selected in step S110 and/or step S120.

In step S140, the swap module 400 may compare the read count value REF_cnt of each of the replacement candidate page data with a second reference value. When the count value REF_cnt is less than or equal to a certain value, the count value REF_cnt may mean that the corresponding page data is being referenced by a relatively small number of processors. For example, when the count value REF_cnt is 0, the count value REF_cnt may mean that the page data corresponding to the count value REF_cnt is not being referenced. Accordingly, as illustrated in FIG. 6, the swap module 400 may efficiently operate the main memory 300 by selecting page data having the count value REF_cnt of 0 as target page data and deleting the target page data from the main memory 300. Accordingly, the swap module 400 may select page data having the count value REF_cnt less than or equal to the second reference value (for example, 0) among the replacement candidate page data as the replacement target page data.

In some embodiments, the method by which the swap module 400 selects the replacement target page data among the first page data 310 is not limited to the present embodiment and may be implemented in various ways. For example, the swap module 400 may omit step S110 and step S120 and perform step S140. That is, the swap module 400 may read all the count values REF_cnt of each of the first page data 310 in the mapping table 320, and then immediately select the page data having the count value REF_cnt less than or equal to the second reference value (for example, 0) as the replacement target page data.

That is, as described above, the flowchart and the detailed description illustrated in FIG. 7 and the present specification are merely an example, and may be implemented differently in other embodiments. For example, an order of some steps may be changed, some steps may be omitted, or another configuration may be added, and some steps described as being performed sequentially may be performed simultaneously.

The electronic device according to an embodiment of the present disclosure may prevent the unnecessary performance degradation of the system that may occur due to the deletion of the page data being referenced by performing the swap operation based on the count value REF_cnt in which the usage state of the page data is reflected in real time. For example, the electronic device according to an embodiment of the present disclosure may improve the efficiency of the system by selecting the page data not being referenced as the replacement target page data based on the count value REF_cnt.

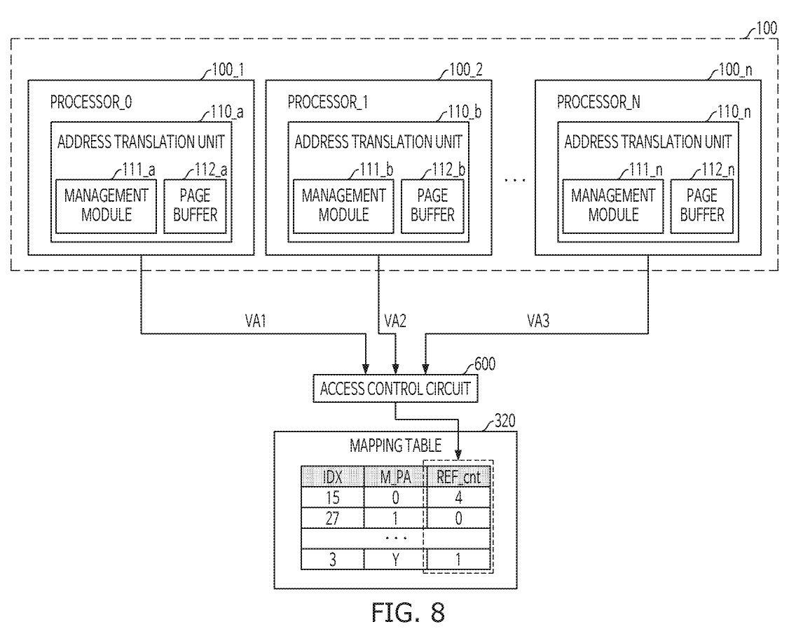

FIG. 8 illustrates an example of data access according to an embodiment of the present disclosure.

Referring to FIG. 8, the computer system 10 may sequentially change the count value REF_cnt through an access control circuit 600. In a multi-core environment, that is, the plurality of processors 100_1, ..., 100_n may multiply (or simultaneously) reference data of the main memory 300. For example, two or more processors may reference identical page data, and access for changing the count value REF_cnt of corresponding page data may be made simultaneously.

For example, the physical address corresponding to the first virtual address VA1 requested by the first processor 100_1 and the physical address corresponding to the second virtual address VA2 requested by the second processor 100_2 may be identical. In some embodiments, the page data including the physical address corresponding to the second virtual address VA2 requested by the second processor 100_2 and the page data including the physical address corresponding to the third virtual address VA3 requested by the n-th processor 100_n may be identical. In other words, even if the physical address corresponding to the second virtual address VA2 and the physical address corresponding to the third virtual address VA3 are different, the page data that the second management module 111_b and the n-th management module 111_n intend to reference may be identical. At this time, access to the mapping table 320 by the first management module 111_a, the second management module 111_b, and the n-th management module 111_n to change the count value REF_cnt of the referenced page data may be made simultaneously. When the access is allowed simultaneously, all of the first management module 111_a, the second management module 111_b, and the n-th management module 111_n may read and change an existing count value REF_cnt, and as a result, a reference status for the page data may not be properly reflected in the mapping table 320.

In an embodiment, the access control circuit 600 may sequentially process accesses when the accesses to the mapping table 320 for changing the count value REF_cnt are made simultaneously (or a plurality of accesses are made within a short period). For example, as described above, the accesses to the mapping table 320 based on the first virtual address VA1, the second virtual address VA2, and the third virtual address VA3 may be made simultaneously, and the access control circuit 600 may control the change of the count value REF_cnt by each access to be made sequentially even if the access control circuit 600 receives the accesses simultaneously. For example, the access control circuit 600 may control to sequentially access the mapping table 320 by performing a buffering operation on the plurality of accesses. The access control circuit 600 may be located within the main memory 300, or may be located outside the main memory 300 to control the plurality of accesses.

The electronic device according to an embodiment of the present disclosure may accurately reflect the usage state for each page data by sequentially controlling the change of the count value REF_cnt.

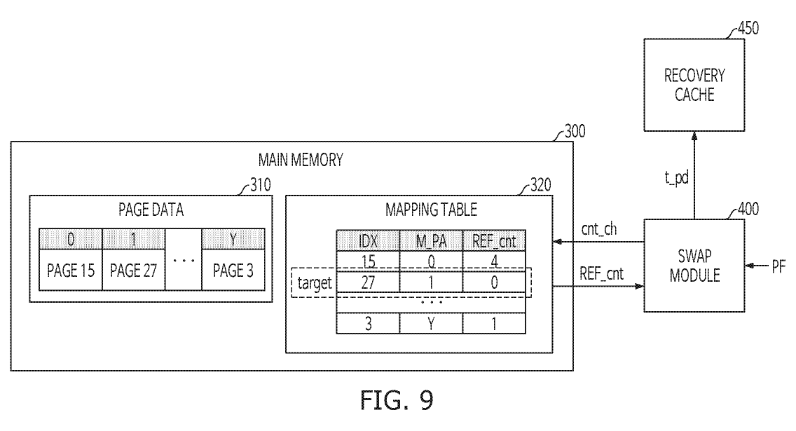

FIG. 9 illustrates an example of data access according to an embodiment of the present disclosure.

Referring to FIG. 9, the swap module 400 may store replacement target page data t_pd in a recovery cache 450. As described above, the swap module 400 may transmit a count check signal cnt_ch to the main memory 300 to read the count value REF_cnt, and may select the replacement target page data t_pd to be deleted from the main memory 300 among the first page data 310 based on the count value REF_cnt. The count check signal cnt_ch may include the first count check signal cnt_ch1 and/or the second count check signal cnt_ch2 of FIG. 6.

As illustrated, the swap module 400 may select page data having the count value REF_cnt less than or equal to a certain value (for example, 0) as the replacement target page data t_pd. At this time, for example, even though the replacement target page data t_pd is page data relatively frequently used by processors, the replacement target page data t_pd may have been selected as the replacement target page data because the count value REF_cnt was less than or equal to the reference value at the time of the swap operation of the swap module 400. In some embodiments, the use of the processors for the replacement target page data t_pd may increase after the swap operation of the swap module 400.

Accordingly, in an embodiment, the swap module 400 may store the selected replacement target page data t_pd in the recovery cache 450. Thereafter, when the virtual address requested by the processor requires the replacement target page data t_pd deleted from the main memory 300 again for a certain period (for example, a preset period), the swap module 400 may load the replacement target page data t_pd stored in the recovery cache 450 into the main memory 300. That is, the swap module 400 may load the page data from the recovery cache 450 without needing to access the storage again to load the page data.

The electronic device according to an embodiment of the present disclosure may separately store the page data deleted from the memory in the cache and maintain the page data for a certain period. Accordingly, even if the processor requests the deleted page data again, unnecessary repetition of the swap operation may be prevented and the performance of the system may be improved by loading directly from the cache instead of accessing the storage device and loading the page data again.

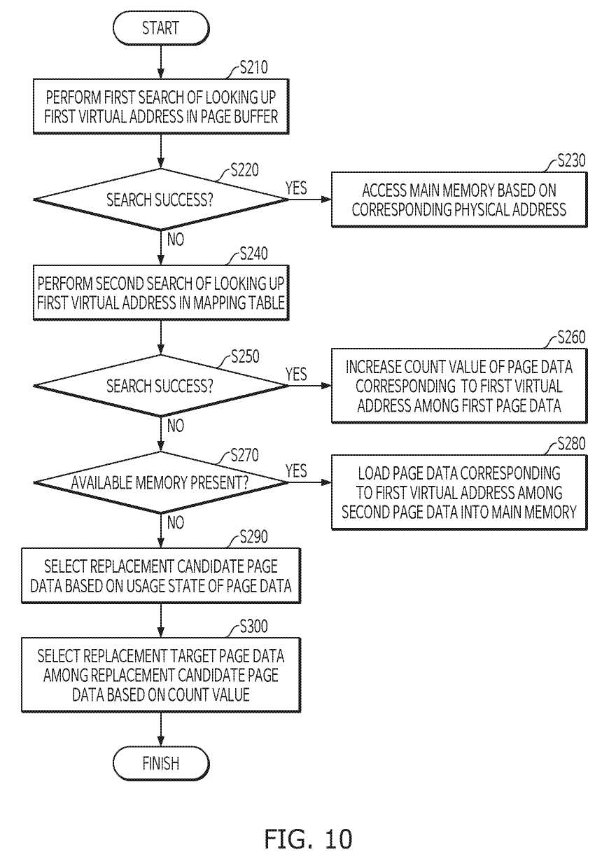

FIG. 10 is a flowchart illustrating an example of a data access method according to an embodiment of the present disclosure.

The data access method according to an embodiment of the present disclosure may include steps S210 to S300. The data access method according to an embodiment of the present disclosure may be performed by the computer system 10, the memory system 1000, and/or the electronic device described with reference to FIGS. 1-9, and overlapping descriptions may be omitted.

In step S210, the electronic device may perform a first search to first lookup the page buffer in the processor in order to access the page data corresponding to the first virtual address requested by the processor.

When the lookup of the page table entry corresponding to the first virtual address succeeds in step S220, that is, the page buffer hit (for example, the TLB hit), in step S230, the electronic device may directly access the main memory after converting the first virtual address into the physical address using the page table entry.

When the lookup of the page table entry corresponding to the first virtual address fails in step S220, that is, the page buffer miss (for example, the TLB miss), in step S240, the electronic device may perform a second search to lookup the mapping table (or the page table) of the main memory to find the page table entry corresponding to the first virtual address.

When the lookup of the page table entry corresponding to the first virtual address succeeds in step S250, that is, a mapping table hit (for example, the page table hit), the electronic device may access the first page data of the main memory by converting the first virtual address into the physical address using the page table entry. Thereafter, in step S260, the electronic device may increase the count value corresponding to the page data corresponding to the first virtual address (that is, the accessed page data) among the first page data.

When the lookup of the page table entry corresponding to the first virtual address fails in step S250, that is, a mapping table miss (for example, the page table miss), in step S270, the electronic device may check whether the available memory is present in order to load the page data corresponding to the first virtual address into the main memory.

When the available memory is present in step S270, in step S280, the electronic device may load the page data corresponding to the first virtual address among the second page data stored in the storage into the main memory.

When the available memory is not present in step S270, in step S290, the electronic device may select the replacement candidate page data based on the usage state of each of the first page data of the main memory. For example, the electronic device may select the replacement candidate page data based on the Least Recently Used (LRU), the First in First Out (FIFO), and/or the Least Frequently Used (LFU) algorithm, and the like.

In step S300, the electronic device may select the replacement target page data among the replacement candidate page data based on the count value. The electronic device may compare the count value of each of the replacement candidate page data with a reference value. The electronic device may select the page data having the count value less than or equal to the reference value as the replacement target page data and delete the selected page data from the main memory. Thereafter, the electronic device may load the page data corresponding to the first virtual address among the second page data stored in the storage into the main memory. In some embodiments, in an embodiment, the electronic device may update the count value of the first page data and/or the replacement candidate page data so that information on the page data being referenced by the processor may be accurately (that is, in real time) reflected. In another embodiment, the electronic device may store the selected replacement target page data in a separate cache. Thereafter, when the processor requests the replacement target page data deleted from the main memory again, the electronic device may directly access the replacement target page data stored in the cache and load the replacement target page data into the main memory.

As described above, the flowchart and the detailed description illustrated in FIG. 10 are merely an example, and may be implemented differently in other embodiments. For example, an order of some steps may be changed, some steps may be omitted, or another configuration may be added, and some steps described as being performed sequentially may be performed simultaneously.

Although the present disclosure has been described with reference to some embodiments in the present specification, various modifications and changes may be made within a scope that does not depart from the scope of the present disclosure that may be understood by the person skilled in the art in the technical field to which the invention of the present disclosure belongs. For example, such modifications and changes should be considered to fall within the scope of the claims appended to the present specification.

What is claimed is:

1. An electronic device comprising:
at least one first processor comprising a page buffer and configured to convert a virtual address into a physical address based on the page buffer;
a main memory configured to store a mapping table and first page data; and
at least one second processor configured to load second page data stored in a storage into the main memory,
wherein the mapping table comprises:
mapping information between the virtual address requested by the at least one first processor and the physical address of the main memory; and
a count value corresponding to each of the first page data and indicating a reference number of times of the at least one first processor for each of the first page data, and
the at least one first processor is configured to,
in response to accessing the first page data with reference to the mapping table, increase the count value corresponding to accessed page data.

2. The electronic device as claimed in claim 1,
wherein the at least one second processor is configured to,
in response to a failure to lookup a first virtual address requested by the at least one first processor in the mapping table, check an available memory to load the second page data in the main memory.

3. The electronic device as claimed in claim 2,
wherein the at least one second processor is configured to,
in response to checking the available memory, load page data corresponding to the first virtual address among the second page data from the storage into the available memory.

4. The electronic device as claimed in claim 2,
wherein the at least one second processor is configured to,
in response to a failure of checking the available memory, select replacement candidate page data among the first page data based on a usage state of page data.

5. The electronic device as claimed in claim 4,
wherein the at least one second processor is configured to,
select the replacement candidate page data based on at least one of a usage frequency, a usage time, and an insertion order into the main memory of each of the first page data.

6. The electronic device as claimed in claim 4,
wherein the at least one second processor is configured to,
exclude page data having the count value greater than or equal to a first reference value among the replacement candidate page data from the replacement candidate page data.

7. The electronic device as claimed in claim 4,
wherein the at least one second processor is configured to,
select page data having the count value less than or equal to a second reference value among the replacement candidate page data as replacement target page data.

8. The electronic device as claimed in claim 7,
wherein the at least one first processor is configured to,
in response to a synchronization request signal of the at least one second processor, transmit a synchronization completion signal to the at least one second processor after completing a change of the count value corresponding to page data currently being referenced, and
wherein the at least one second processor is configured to,
in response to the synchronization completion signal, read the count value.

9. The electronic device as claimed in claim 1,
wherein the main memory further comprises,
an access control circuit configured to sequentially process one or more accesses for an increase of the count value of a corresponding processor of the at least one first processor included in the corresponding processor of the at least one first processor.

10. The electronic device as claimed in claim 7,
further comprising a recovery cache configured to store the replacement target page data.

11. The electronic device as claimed in claim 10,
wherein the at least one second processor is configured to,
in response to a request for a virtual address corresponding to the replacement target page data stored in the recovery cache during a preset period, load the replacement target page data into the main memory.

12. A method of operating an electronic device performed by at least one processor comprising a page buffer, and a main memory configured to store a mapping table storing mapping information between a virtual address and a physical address and first page data, the method comprising:
performing a first search of looking up a first virtual address requested by the at least one processor in the page buffer;
in response to a failure of the first search, performing a second search of looking up the first virtual address in the mapping table;
in response to a failure of the second search, loading page data corresponding to the first virtual address among second page data stored in a storage into the main memory; and
updating the mapping table based on the mapping information of corresponding page data loaded into the main memory,
wherein the performing of the second search comprises,
in response to accessing the first page data with reference to the mapping table, increasing a count value of page data corresponding to the first virtual address among count values indicating a reference number of times for each of the first page data.

13. The method as claimed in claim 12,
wherein the loading the page data into the main memory comprises:
checking an available memory to load the second page data in the main memory; and
in response to a failure of checking the available memory, selecting replacement candidate page data among the first page data based on a usage state of page data.

14. The method as claimed in claim 13,
wherein the selecting the replacement candidate page data comprises:
selecting page data having the count value less than or equal to a reference value among the replacement candidate page data as replacement target page data.

15. An electronic device, comprising:
at least one first processor configured to convert a virtual address into a physical address based on a page buffer;
a main memory configured to store a mapping table and first page data; and
at least one second processor configured to load second page data stored in a storage into the main memory,
wherein the mapping table comprises:
mapping information between the virtual address requested by the at least one first processor and the physical address of the main memory; and
a count value corresponding to each of the first page data and indicating a reference number of times that the at least one first processor has accessed each of the first page data with reference to the mapping table,
wherein the at least one first processor is configured to:
in response to a failure of a lookup of a first virtual address in the page buffer, lookup the first virtual address in the mapping table, and
in response to a failure of the lookup of the first virtual address in the mapping table, transmit a page fault signal to the at least one second processor, and
wherein the at least one second processor is configured to:
in response to the page fault signal, check an available memory to load the second page data in the main memory,
in response to a failure of checking the available memory, select replacement candidate page data based on at least one of a usage frequency, a usage time, and an insertion order into the main memory of page data, and
select page data having the count value less than or equal to a reference value among the replacement candidate page data as replacement target page data.
